(19) United States
(12) Patent Application Publication
(10) Pub. No.: US 2019/0183246 A1
(43) Pub. Date: Jun. 20, 2019

(54) SHELVING SYSTEM

(71) Applicant: Marijan BERNIC, Manhasset, NY (US)

(72) Inventor: Marijan BERNIC, Manhasset, NY (US)

(21) Appl. No.: 15/842,018

(22) Filed: Dec. 14, 2017

(51) Int. Cl. A47B 96/02; A47B 96/06; F16B 7/04; A47B 96/07

(52) U.S. Cl. CPC A47B 96/028; A47B 96/07; F16B 7/042; A47B 96/068

(57) ABSTRACT

An improved shelving system comprises a shelf, a plurality of posts supporting the shelf and a quick release clamp attached to a post. The shelf is supported by the clamp and the clamp can be tightened around the post and loosened from the post by hand, without the need for tools. The clamp can include a hinged jaw portion formed with two arms and a clasp portion on each arm. The quick release nature of the clamp permits fast and convenient reconfiguration of the shelving system, preferably without the need for tools. Accordingly, a method of assembling and disassembly a shelving system involving the quick-release clamp system is also provided.

### TECHNICAL FIELD

The present disclosure relates generally to shelf and rack systems for storing goods.

### BACKGROUND

Shelving systems, including those having shelves made of wire racks are common. Conventionally, those shelves are supported by metal support posts. The shelves typically include fittings at each corner. The fittings are slipped over the posts and are generally press-fit into frictional engagement at a desired location on the post to position the shelf at the desired height.

Conventional shelving systems, including conventional wire rack systems, have disadvantages. For example, it is often inconvenient and often requires tools to disassemble a shelving system and reconfigure it at different heights. The fittings can become damaged or the posts can become damaged as the fittings are often hammered loose from their initial position on the support posts.

Other systems include nuts and bolts to fasten the shelves to the support posts. It can be time consuming to assemble and disassemble the shelving systems by tightening and loosening nut and bolt fastening systems.

Accordingly, it is desirable to provide an improved shelving system having a more convenient construction for assembly and disassembly and which overcomes disadvantages of the prior art.

### SUMMARY OF THE INVENTION

Generally speaking, in accordance with the invention, an improved shelving system is provided, comprising a shelf, a plurality of posts supporting the shelf and a quick release clamp attached to a post. The shelf is supported by the clamp and thereby, supported by the post.

The clamp can include a hinged jaw portion formed with two arms and a clasp portion on each arm. In one embodiment of the invention, the clasp includes one or more resilient projections on one jaw of the clasp, which engages a recess on the other jaw. The clasp can include a plunger that upon activation, permits the projection(s) to retract and the jaws of the clasp to open. In another embodiment of the invention, the clasp is hand screwed tight and then the final tightening is achieved by hand pivoting a lever mechanism. In still another embodiment of the invention, The posts have grooves at spaced intervals. The inner surface of the clamp arms include an inwardly projecting ridge. The ridge fits in a groove on the posts and helps maintain the clamp in a selected position.

The quick release nature of the clamp permits fast and convenient reconfiguration of the shelving system to different heights without the need for tools, by hand tightening and loosening the clamp. Accordingly, a method of assembling and disassembling or reconfiguring a shelving system involving a quick-release clamp is also provided.

Other embodiments of the invention will be apparent from the drawings and the specification to follow and the scope of the invention will be indicated in the claims.

### BRIEF DESCRIPTION OF THE DRAWINGS

The present disclosure will become more readily apparent from the specific description accompanied by the following drawings, which are not necessarily to scale, in which:

FIG. 1 is a perspective view of a quick release clamp, in an open configuration, in accordance with an embodiment of the invention;

FIG. 2 is a top view of the clamp of FIG. 1, in a closed configuration, gripping a post (shown in cross-section), in accordance with an embodiment of the invention;

FIG. 3 is an enlarged cross-sectional view of a clasp portion of the clamp of FIG. 1;

FIG. 4A is an exploded perspective view of a quick release portion of a clamp in accordance with an embodiment of the invention;

FIG. 4B is a perspective view of the assembled quick release of FIG. 4A;

FIG. 5 is a perspective view of a quick release clamp, in accordance with another embodiment of the invention;

FIG. 6 is a perspective view of a shelf assembly, in accordance with a preferred embodiment of the invention;

FIG. 7 is an enlarged perspective view of a portion of the assembly of FIG. 6;

FIG. 8 is a perspective view of a clamp, in accordance with another embodiment of the invention.

Throughout the disclosure, like reference numerals will be used to indicate similar elements.

### DETAILED DESCRIPTION OF PREFERRED EMBODIMENTS

The present disclosure may be understood more readily by reference to the following detailed description, taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments, by way of example only, and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. In particular, they are intended to refer to the spatial reference of the display stand in its normal, assembled configuration during intended use.

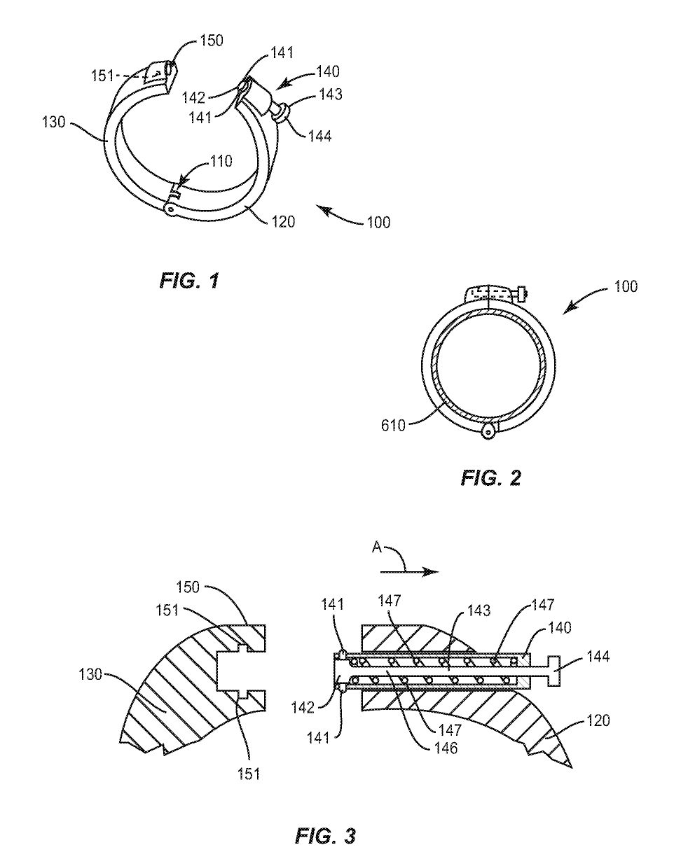

A quick-release clamp, in an open condition, in accordance with a preferred embodiment of the invention, is shown generally as clamp 100 in FIG. 1. Clamp 100 includes a hinge 110 connecting a male arm 120 and a female arm 130 extending from hinge 110.

Male arm 120 includes a male portion of a clasp 140, shown in detail in FIG. 3. Clasp 140 includes a pair of projections 141 which are forced outwards by a wide distal end 142 of a plunger 143. Wide distal end 142 is wider than a narrow section 146, proximal to wide distal end 142. Plunger 143 is biased in the proximal direction of an arrow A by a spring 147. Accordingly, when a button 144 at the proximal end of plunger 143 is activated against the resilience of spring 147, wide distal end 142 moves past projections 141, and permits projections 141 to slide inward towards narrow section 146 of plunger 143. This disengages clasp 140 from female arm 130 and permits clamp 100 to swing open, as discussed in further detail below.

FIG. 2 depicts clamp 100 in the closed condition around a post 610. As shown in FIGS. 1 and 2, plunger 143 is extended in the proximal direction, with wide distal end 142 forcing projections 141 outward. This causes projections 141 to be fixed in a pair of recesses 151 of a receiving section 150 of female arm 130. Because wide distal end 142 prevents projections 141 from moving inwardly, clasp 140 remains securely attached to receiving section 150, which keeps male arm 120 fixed to female arm 130 and keeps clamp 100 in the closed condition. The inner diameter of clamp 100 is sized to be slightly less than the outer diameter of post 610, which supports the shelf. Consequently, clamp 100 will remain tightly attached to post 610 until the quick release is activated by activating plunger 143. In certain embodiments of the invention, high friction material, such as rubber or plastic can be disposed on the inner surface of clamp 100 to improve the grip to post 610.

To remove clamp 100 from post 610 and disengage the quick release holding arm 120 to arm 130, button 144 is pressed in a direction opposite arrow A, against the resilience of spring 147, which moves wide end 142 past projections 141. This permits projections 141 to retract inwards and clasp 140 will swing away from receiving end 150.

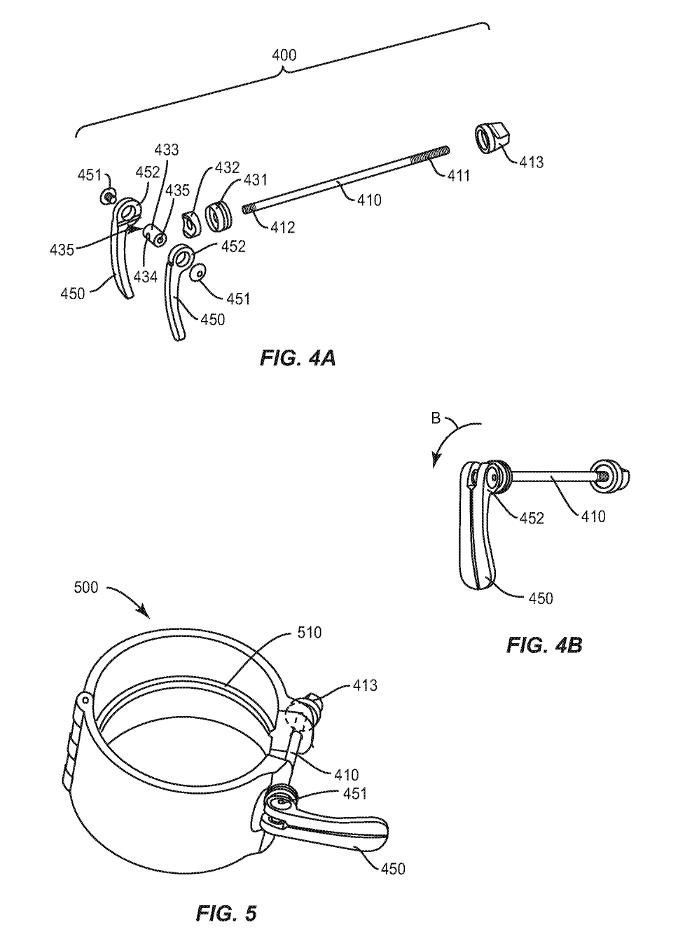

A lever-assisted quick release in accordance with another embodiment of the invention is shown generally in FIGS. 4A and 4B, as lever release 400. Lever release 400 includes a rod 410 having a far threaded end 411 and a near threaded end 412. A threaded cap nut 413 can be fingered tightened over far threaded end 411. A washer 431 is slipped over near threaded end 412 and a cupped washer 432 is nested therein. Cupped washer 432 includes a concave surface to receive a threaded cylinder 433. Threaded cylinder 433 is threaded over near threaded end 412 at a threaded opening 434 through cylinder 433. A one-piece (not shown) or a two-piece lever 450 is slipped over cylinder 433 and held in place by a screw 451 into a threaded opening 435 of threaded cylinder 433.

To operate lever-assisted quick release 400, it is initially fingered tightened around a post by either tightening cap nut 413 or twisting lever 450. The base portion of lever 450 includes a cam 452. Final tightening is accomplished by pivoting lever 450 in the direction of an arrow B, which further tightens quick release 400.

Another shelf supporting clamp in accordance with another embodiment of the invention is shown generally as ridged clamp 500 in FIG. 5. Ridged clamp 500 is shown with lever release 400. However, the quick release structure of clamp 100 or a different quick release can be used. Likewise, a clamping portion with a ridge can be employed with the other features of clamp 100.

Ridged clamp 500 includes a ridge 510 on its inner surface. The post supporting the shelf can be formed with grooves, spaced at selected intervals. Ridge 510 can be received in those grooves to provide additional support for ridged clamp 500 and thereby, the shelf resting on clamp 500.

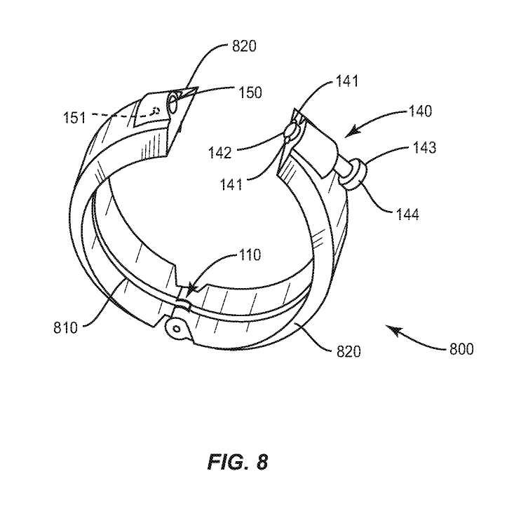

A clamp for supporting a rack shelf in accordance with another preferred embodiment of the invention, is shown generally in an open condition as clamp 800 in FIG. 8. Clamp 800 is similar in construction to clamp 500, but includes a pair of tapered edges 820 on what will be the upper and lower walls thereof. In another embodiment of the invention, only the upper or only a lower wall is tapered and the other is flat.

As shown, clamp 800 includes a ridge 810 on its inner surface. The post supporting the shelf can be formed with grooves, spaced at selected intervals. Ridge 810 can be received in those grooves to provide additional support for ridged clamp 800 and thereby, the shelf resting on clamp 800. In another embodiment of the invention, clamp 800 is formed without ridge 810 (not shown) and has an inner surface similar to that of claim 100.

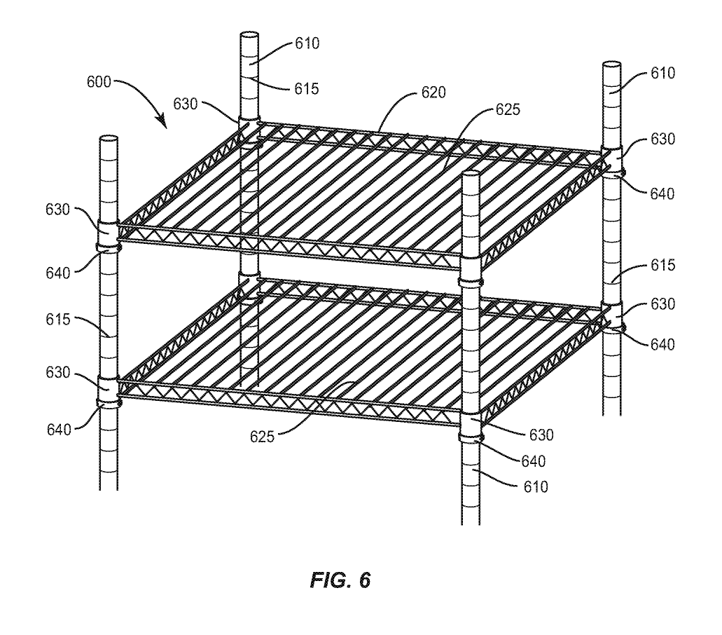

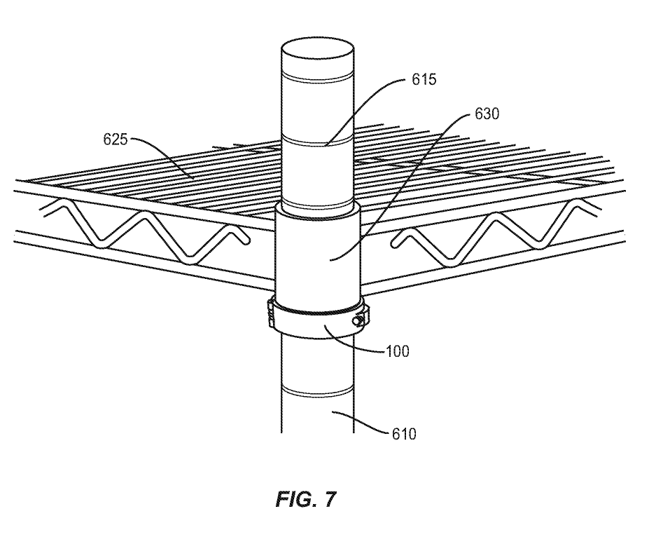

An shelf assembly in accordance with a preferred embodiment of the invention is shown generally in FIG. 6 as shelf system 600. Shelf system 600 includes four posts 610. Each post 610 can have an outer diameter of approximately one-inch, 0.75 inches, 1.25 inches or any other dimension as desired. Each post 610 includes spaced grooves 615. Grooves 615 can be spaced at regular intervals, such as every 0.5, 0.75, 1.0, 1.25, 1.5 inches or any spacing as desired.

Shelf system 600 includes one or more shelves 620 having a wire rack 625 structure. Other shelf structures can be used. Each shelf 620 includes four post fittings 630. Post fittings 630 are slipped over post 610 and held up by resting on a quick release clamp 640 secured to post 610, in accordance with an embodiment of the invention. Clamp 640 can be similar to clamps 100 or 500 or can be a different quick release clamp and may or may not have a ridge to engage the grooves in post 610.

To assemble shelf system 600, clamps 640 are attached to posts 610. Post fittings 630 of a shelf 620 are slipped over each post 610 and slid down, to rest on quick release clamp 640. If a location of a shelf, with respect to a post 610, is desired to be changed, the entire assembly need not be disassembled. Rather, the clamps and shelves can be repositioned by hand, without the need for tools. In fact, quick release clamps in accordance with the invention need not be removed from the post. Rather, the quick release feature can loosen their attachment to the posts and the clamps and shelves can be hand repositioned in a convenient manner, without the need for any tools.

In another embodiment of the invention, clamp 800 is used in place of clamp 640 when assembling shelf system 600. In this embodiment of the invention, upper surface of clamp 800 is tapered edge 820. The lower edge of post fitting 630 can slip over tapered edge 820 and assist with the security of the assembly, by helping force clamp 800 tightly around post 610.

Please note that where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claims.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

1. A shelving assembly having a quick release clamp, comprising:
at least one post;
the quick release clamp of claim 10 attached to the post; and
a shelf supported by the quick release clamp on the post.

2. The shelving assembly of claim 1, wherein the shelf is formed of a wire framework.

3. The shelving assembly of claim 1, wherein the quick release clamp includes a spring-loaded plunger and at least one projection and one recess, adapted and configured to hold the arms together in a closed condition gripping the post, until the plunger is pressed, to permit retraction of the projection from the recess and opening of the arms.

4. The shelving assembly of claim 1, wherein the quick release clamp includes a rotatable lever, in ramming engagement with the quick release clamp, the lever adapted and configured to tighten the clamp with a threaded connector and then pull the clamp into a tighter configuration by pivoting the lever.

5. The shelving assembly of claim 1, wherein a ridge extends inwardly from the inner surface of each arm.

6. The shelving assembly of claim 5, wherein the post includes a plurality of grooves and the ridge is engaged in one of the grooves.

7. The shelving assembly of claim 6, wherein the grooves are approximately 0.5, 0.75, 1.0, 1.25 or 1.5 inches apart.

8. The shelving assembly of claim 1, wherein the nominal inner diameter of the clamp, in the closed configuration, is slightly less than the nominal outer diameter of the post and when the clamp is in the closed condition around the post, the post is slightly compressed by the clamp and the clamp is slightly expanded around the post.

9. The shelving system of claim 1, wherein the quick release clamp is adapted to permit loosening and re-clamping by hand to change the position of the clamp on the post without the use of tools and without removing the shelves from the posts.

10. A quick release clamp for a shelving system, comprising:
a pair of first and second arms connected by a hinge, the arms having an inner surface adapted to grip the outer surface of a post supporting a shelf;
the arms having a quick release connector portion at each end, configured to hold the arms together and the connector configured to release the arms upon the moving of an activator.

11. The quick release clamp of claim 10, Wherein the connector comprises a plunger on the end of the first arm and a receptacle on the end of the second arm, the plunger having at least one retractable projection and the receptacle having at least one recess configured to receive the projection and hold the clasp in a closed configuration, the plunger having an activator adapted to permit retraction and opening of the clasp when the activator is activated.

12. The quick release clamp of claim 10, wherein the inner surface of the arms comprise an inwardly extending ridge.

13. The quick release clamp of claim 10, wherein the quick release includes a rotatable lever, in camming engagement with the quick release connector, the lever adapted and configured to tighten the connector with a threaded connector and then pull the connector into a tighter configuration by pivoting the lever.

14. The quick release clamp of claim 10, wherein the quick release connector is adapted to permit loosening and re-clamping by hand to change the position of the clamp on the post without the use of tools.

15. The quick release clamp of claim 10, wherein the nominal inner diameter of the clamp, in the closed configuration, is slightly less than 1 inch and adapted to close around a post with a nominal 1 inch outer diameter.

16. A method of configuring a shelf system, comprising:
attaching four clamps, each with a quick release clasp to a respective post by hand, without the use of tools, at a first height with respect to each post;
slipping a post fitting of a shelf over an end of each post and positioning the fitting of the shelf on the clamp; and then
hand loosening the clamp, repositioning the clamp, then tightening the clamp and repositioning the shelf at a second height with respect to the post, without removing the post fittings from the posts.

17. The method of claim 16, the quick release clasp is opened by pressing a plunger which disengages at least one projection from a respective portion of the clasp.

18. The method of claim 16, wherein the clamp and post are slightly deformed as the clamp is closed around the post.
